(19) United States
(12) Patent Application Publication
(10) Pub. No.: US 2024/0287987 A1
(43) Pub. Date: Aug. 29, 2024

(54) SEALANT APPLICATION SYSTEM

(71) Applicant: Airbus Operations Limited, Bristol (GB)

(72) Inventors: Benjamin HUMPHRYS, Bristol (GB); Hamza TAMIM, Bristol (GB)

(21) Appl. No.: 18/423,949

(22) Filed: Jan. 26, 2024

(30) Foreign Application Priority Data
Jan. 27, 2023 (GB) 2301223.0

(51) Int. Cl. F04C 15/00

(52) U.S. Cl. CPC F04C 15/0026; F04C 15/0061; F04C 2230/60

(57) ABSTRACT

A sealant application includes an interface structure having an interface for interfacing with a source of sealant and a nozzle structure including a nozzle for dispensing sealant. A gear pump module including a gear pump is configured to be detachably connectable to each of the interface structure and the nozzle structure such that sealant provided at the interface is pumpable by the gear pump from the interface to the nozzle.

### TECHNICAL FIELD

The disclosure herein relates to sealant application systems.

### BACKGROUND

Sealant is widely used in aerospace and other industries in order to, amongst other uses, prevent leakage of fluids and air, reduce risk of crevice corrosion, fill cavities, and suppress electrical discharges arriving from lightning strikes. Correct application of sealant is critical for, for example, avoidance of leaks, weight saving, material saving, and cosmetic acceptability. The application of sealant is usually a manual activity and reliant upon the skill and diligence of the operator applying it. Routine sealing tasks can be a costly process, particularly when factoring in the labour required for preparation and application of sealant.

Dispensing sealant automatically in a reliably controlled and precise manner is challenging due to the nature of the compounds used. Sealants are typically two-component materials which are mixed when required and cure relatively quickly. The sealant viscosity and rheological properties vary from batch to batch.

Existing methods include pneumatic or electro-pneumatic systems, which regulate sealant flow by air pressure only and without feedback, which means the sealant flow is not fixed. Additionally, exposure to high pressure is not suitable for some low-density sealants. Screw-type feeder units are large due to the necessary length of the lead screw and motor, and are prone to contamination from residual sealant and must be cleaned if so. The large size of screw-type feeder units means they are difficult to adapt for collaborative robot usage with human operators. Progressive-cavity pumps use a rotor inside a stator to obtain well-controlled volumetric dispensing. However, the dispenser element must be accurately machined which makes them expensive. Unless they are correctly cleaned down at the end of use, the dispenser rotor and stator may be difficult and time-consuming to repair or replace.

It is desirable to provide an improved sealant application system which can enable sealant to be applied accurately and reliably while mitigating the aforementioned problems.

### SUMMARY

A first aspect of the disclosure herein provides a sealant application system, comprising an interface structure comprising an interface for interfacing with a source of sealant; a nozzle structure comprising a nozzle for dispensing sealant; and a gear pump module comprising a gear pump, the gear pump module comprising a gear pump, the gear pump module configured to be detachably connectable to each of the interface structure and the nozzle structure such sealant provided at the interface is pumpable by the gear pump from the interface to the nozzle.

The sealant application system, having such a gear pump module, can reliably apply doses of sealant such that each dose of sealant is of a well-controlled volume. The gear pump module can dispense sealant without requiring high-pressure air and so is suitable for use with low-density sealants. The gear pump module is detachably connectable to the interface structure and to the nozzle structure. In this way, the sealant application system is modular. The source of sealant can be changed if, for example, multiple sealant types are to be used in a given application process. The nozzle can be changed such that the manner in which the sealant is applied can be changed. The gear pump mechanism can be changed for another gear pump mechanism. In this way, the sealant application system has improved operational flexibility and versatility.

Optionally, the gear pump module is configured to receive a drive shaft for driving the gear pump, and the sealant application system further comprises the drive shaft. This allows the gear pump module to be driven by an external motor or manually, for example.

Optionally, the sealant application system further comprises a motor operable to drive the gear pump. In some examples, the motor drives the gear pump by driving the drive shaft mentioned above. In some examples, the motor is a stepper motor. A motor allows the gear pump to be driven in an automated fashion. A stepper motor allows for regularly sized doses of sealant to be applied.

Optionally, the sealant application system further comprises a source of sealant, the source of sealant interfaceable with the interface structure. In examples, the source of sealant is a cartridge of pre-mixed sealant.

Optionally, the sealant application system further comprises a device operable to apply pressure to the source of sealant such that sealant is provided to the interface under pressure. Applying pressure to the sealant can prevent cavitation of the pump which may otherwise stop the sealant feed and/or damage the pump. Applying pressure can thereby improve the reliability of flow of the sealant to and/or through the gear pump module. The device could be, for example, a pneumatically-powered device, an electrically-powered device, a hydraulically-powered device, or a manually-powered device. In examples, the sealant is provided to the gear pump mechanism at a pressure less than 30 bar, for example 2-5 bar. This can avoid damaging the sealant, for example where the sealant contains hollow sphere additives. Providing approximately 2 bar of pressure, for example, can prevent pump cavitation while preventing damage to hollow-sphere sealants and without causing leakage from the pump body or dispensing nozzle.

Optionally, the sealant application system further comprises a sealant dosage control unit configured to cause driving of the gear pump module such that the sealant application system dispenses a selectable dosage of sealant. This allows the volume of sealant being dispensed as a dose to be varied during use. This can improve the operational flexibility and versatility. In some examples where a motor is provided, the sealant dosage unit provides a control signal to the motor to determine a sealant dosage volume. In some examples where a stepper motor is provided, the sealant dosage unit defines a number of steps taken by the stepper motor in order determine a sealant dosage volume.

A second aspect of the disclosure herein provides a sealant application system gear pump module for a sealant application system, the sealant application system gear pump module comprising: a body defining: an input port configured to be detachably connectable to an interface structure, the interface structure comprising an interface for interfacing with a source of sealant, an output port configured to be detachably connectable to a nozzle structure, the nozzle structure comprising a nozzle for dispensing sealant, and a cavity that fluidically connects the input port to the output port; and a gear pump in the cavity and operable to pump sealant received at the input port to the output port.

The sealant application system gear pump module is able to reliably apply accurate doses of sealant, having a well-controlled volume. The sealant application system gear pump module, having an input port detachably connectable to an interface structure comprising an interface for interfacing with a source of sealant, can therefore be used interchangeably with a variety of sealant sources, improving the operational versatility of the sealant application system gear pump module. Similarly, the sealant application system gear pump module, having an output port detachably connectable to a nozzle structure comprising a nozzle for dispensing sealant, can therefore be used interchangeable with a variety of nozzles, improving the operational versatility of the sealant application system gear pump module.

Optionally, the sealant application system gear pump module comprises discrete first and second portions, the first portion and the second portion being attached to each other to form the body. In examples, the first portion and the second portion are retained together by fasteners. In examples, the first portion and the second portion are retained together by adhesive disposed between the two portions. In examples, the first portion and the second portion are retained together by a snap-lock mechanism. In examples, plural retainment mechanisms, such as any combination of those discussed in this paragraph, are used concurrently.

Optionally, each of the first portion and the second portion is a monolithic structure. The first portion and second portion can therefore be straightforwardly manufactured by injection molding, or additive manufacturing, without requiring combination of a plurality of subcomponents. Construction of the gear pump module can be simplified due to the reduced number of components. This can also reduce the likelihood of leaks as the portions, being monolithic, have fewer interfaces through which leaks could occur. This improves the performance of the sealant application system gear pump module by, for example, reducing wasted sealant by leakage.

Optionally, the input port and the output port are formed by attachment of the first portion to the second portion. Attachment of the input port or the output port to the interface structure or the nozzle structure, respectively, can act to further secure the first portion to the second portion. This can improve a seal formed between the first portion and the second portion to reduce the likelihood of leaking.

Optionally, the first portion and the second portion are configured such that the cavity is sealed at adjoining surfaces of the first and the second portions. This can reduce the likelihood of leakage of sealant within the cavity. In some examples, the first and second portions are configured to form a labyrinth seal at their adjoining surfaces. This allows the first and second portions to be straightforwardly detachable from one another while providing a sealing effect.

Optionally, at least one of the first portion and the second portion comprises a knock-out portion, the knock-out portion being forcibly removable from the at least one of the first portion and the second portion to produce an opening into the cavity configured to receive a drive shaft for powering the gear pump.

Optionally, the first portion and the second portion are identical to each other. This can allow the manufacture of the gear pump module to be simplified by requiring fewer unique parts to be produced. This can also avoid mismatch in quantities of disparate portions for an operator, such that the sealant application gear pump module is more reliably constructed.

Optionally, the body comprises an opening configured to receive a drive shaft for powering the gear pump. This allows the gear pump housed within the body to be driven externally from the body. This can prevent the external driver from being exposed to or in close proximity to sealant. In some examples where the body is comprised of a portion comprising a knock-out portion, the opening is formed by removal of a knock-out portion.

Optionally, the sealant applicator gear pump module comprises additively manufactured components. In examples, the first portion and the second portion are additively manufactured. In examples, all the components of the gear pump module are additively manufactured. Being additively manufactured, components can be readily reproduced and replace disposed components. The sealant applicator gear pump module being readily disposable and replaceable can be more cost-efficient than cleaning. The additively manufactured components may be made of biodegradable or recyclable materials to further improve their disposability.

Optionally, the gear pump comprises an external gear pump. In examples, the gear pump comprises at least one of an external gear pump, internal gear pump, and micro-annular gear pump.

Optionally, a gear of the gear pump comprises a non-circular central hole such that the gear is configured to receive, and be driven by, a drive shaft. A drive shaft permits the gear pump to be driven externally, such that the driving mechanism of the drive shaft is not in close proximity to or exposed to the sealant in the gear pump.

Optionally, the input port and the output port comprise male or female threaded fittings. Threaded fittings can be straightforwardly connected and disconnected to an interface structure or a nozzle structure, which can make the sealant application system gear pump module quick to install.

According to a third aspect of the disclosure herein there is provided a kit of components that are operable to be assembled to form the sealant application system gear pump module according to the second aspect of the disclosure herein. The kit of components comprises the first portion and the second portion, which are attachable to each other to form the body; and two or more parts that are operable to be assembled to form the gear pump. Such a kit may be more easily stored or transported due to the components being disconnected from one another, and later be assembled to form the sealant application system gear pump module when needed.

Features described for, and associated advantages realized by, the sealant application system gear pump module are also applicable to a sealant application system comprising the sealant application system gear pump module, such as the first aspect of the disclosure herein. The sealant application system gear pump module may be constructed from a kit of components according to the third aspect of the disclosure herein, and the sealant application system may comprise such a gear pump module being constructed from a kit of components.

### BRIEF DESCRIPTION OF THE DRAWINGS

Embodiments of the disclosure herein will now be described, by way of example only, with reference to the accompanying drawings, in which:

FIG. 1 shows a schematic view of a sealant application system.

FIG. 2 shows an exploded perspective view of a gear pump module.

FIGS. 3a, 3b illustrate cross-sectional views of alternative gear pump modules.

### DETAILED DESCRIPTION

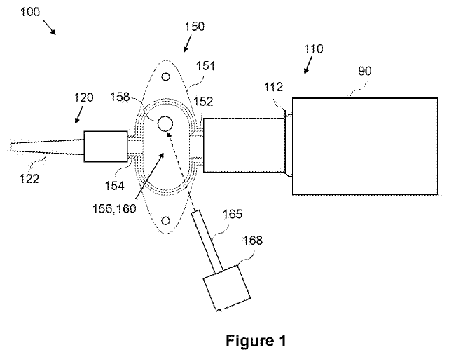

FIG. 1 illustrates an example of a sealant application system 100. The sealant application system comprises an interface structure 110, a gear pump module 150, and a nozzle structure 120.

The interface structure 110 comprises an interface 112 for interfacing with a source of sealant 90. The source of sealant 90, in this example, is a canister of premixed sealant 90. The source of sealant 90 provides sealant to the interface structure 110 of the sealant application system 100. In this example, the canister of premixed sealant 90 stores the sealant under positive pressure such that sealant is provided to the interface structure 110 under positive pressure.

The gear pump module 150 comprises a body 151 defining an input port 152 and an output port 154 fluidically connected by a cavity 156. The input port 152 is connected to the interface structure 100 such that the input port 152 of the gear pump module 150 receives sealant. The cavity 156 houses a gear pump 160. The body 151 further comprises an opening 158 into the cavity. A drive shaft 165 is provided, passes through the opening 158, and interfaces with the gear pump 160. Rotation of the drive shaft 165 drives the gear pump 160 such that the gear pump 160 is operable to pump sealant received at the input port 152 to the output port 154. In this example, the drive shaft 165 is rotated by a stepper motor 168, located externally to the gear pump module 150. The gear pump is a fixed-displacement pump, delivering a fixed quantity of sealant from the output port 154 per rotation of the drive shaft 165. The stepper motor 168 rotates the drive shaft 165 by steps of a fixed angle. The sealant application system 100 is therefore operable to dispense doses of sealant having a fixed volume from the sealant source 90.

The nozzle structure 120 is attached to the output port 154 of the gear pump module 150. The nozzle structure 120 comprises a nozzle 122 for dispensing sealant. When the gear pump 160 pumps sealant through the cavity 156 to the output port 154, the sealant is dispensed from the nozzle 122 of the nozzle structure 120. In this example, the nozzle structure 122 is a solid, cone-shaped nozzle, but in other examples may be flexible or comprise a flexible portion. The nozzle permits sealant to be precisely dispensed, for example, at a specific spot size or in a particular direction.

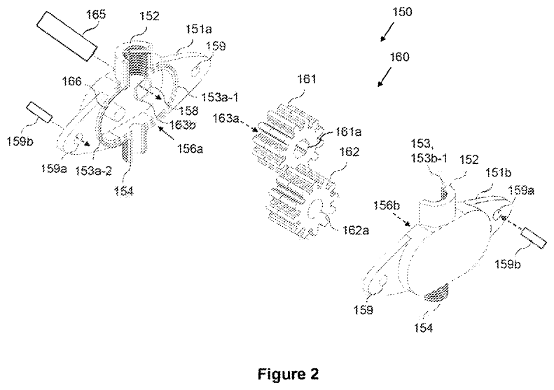

FIG. 2 illustrates the gear pump module 150 in an exploded view such that constituent components of the gear pump module 150 can be seen. This view can also be considered to represent the gear pump module 150 in a kit form, where the constituent components are provided separately and assembled to form the gear pump module 150 and/or the sealant application system 100.

The body 151 of the gear pump module 150 comprises a first portion 151a and a second portion 151b. The first portion 151a and second portion 151b are discrete portions which are attachable to each other to form the body 151. In this example, the first portion 151a forms a first half of the body 151 and the second portion 151b forms a second half of the body 151.

The first portion 151a comprises a half of the input port 152, a half of the output port 154, the drive shaft opening 158, and a surface which forms a first half cavity 156a of the cavity 156. The second portion 151b comprises a second half of the input port 152, a second half of the output port 154 and a surface which forms a second half cavity 156b of the cavity 156. When the first portion 151a is attached to the second portion 151b, the input port 152, output port 154, and cavity 156 are formed from the respective halves.

The input port 152 is a male-threaded fitting, which allows it to be screwed into the interface structure 110. The output port 154 is a female-threaded fitting, which allows the nozzle structure 120 to be screwed into the output port 154. The gear pump module 150 is therefore detachably connectable and reconnectable from both the interface structure 110 and the nozzle structure 120. In other examples, adapters may also be provided in order to connect the gear pump module 150 to other interface structures or nozzle structures.

The input port 152 and output port 154 being formed by the combination of the first portion 151a with the second portion 151b improves the strength of connection between the first portion 151a and the second portion 151b because the interface structure 110 and the nozzle structure 120 act to clamp their respective ports and hence further secure the first portion 151a to the second portion 151b. This can reduce the likelihood of sealant leaking between the two portions 151a, 151b.

The first portion 151a comprises a first seal portion 153a and the second portion 151b comprises a corresponding second seal portion 153b (not directly visible in FIG. 2). In this example, the first seal portion 153a comprises a first ridge section 153a-1 which runs from the output port 154 to the input port 152 and partially bounds a first side of the first half cavity 156a. The first seal portion 153a also comprises a first groove section 153a-2 which runs from the outport port 152 to the input port 152 to partially bound a second side of the first half cavity 156a. The first ridge section 153a-1 and the first groove section 153a-1 of the first seal portion 153a thereby effectively form a perimeter around the first half cavity 156a, excluding the presence of the output port 154 and the input port 152. The second seal portion 153b similarly comprises a corresponding second ridge section 153b-1 and a corresponding second groove section 153b-2 forming a perimeter around the second half cavity 156b.

The seal portions 153a,b are arranged on their respective portions 151a, 151b such that when the first portion 151a is attached to the second portion 151b to form the cavity 156, the first seal portion 153a interfaces with the second seal portion 153b to form a seal 153 at the adjoining surfaces of the first portion 151a and the second portion 151b. The seal 153 seals the cavity 156. When the first seal portion 153a interfaces with the second seal portion 153b, the first ridge section 153a-1 is received by the second groove section 153b-2 and the second ridge section 153b-1 is received by the first groove section 153a-1. The seal 153 can therefore be considered a labyrinth seal. In other examples, other designs of labyrinth seal may be provided, for example comprising a plurality of grooves and ridges on each of the first and second portions 151a, 151b. The labyrinth seal may be duplicated such that the seal portion comprises plural labyrinth seals to further improve the quality of the seal formed.

The seal 153 ensures sealant within the cavity 156 only leaves the cavity 156 by the output port 154 and reduces the likelihood of sealant leaking from other locations at the interface between the two portions 151a, 151b. The seal 153 being a labyrinth seal means the first seal portion 151a can be straightforwardly disengaged from the second seal portion 151b when the first portion 151a of the body 151 is detached from the second portion 151b of the body 151, as the seal 153 does not require use of an adhesive, for example. This can improve the speed at which the gear pump module 150 can be assembled and disassembled.

The first portion 151a of the body 151 and the second portion 151b of the body 151 each comprise fastening holes 159a through which fasteners 159b can be threaded such that the first portion 151a can be fastened to the second portion 151b when attached to each other. The fastening of the first portion 151a to the second portion 151b by the fasteners 159 retains the ridge sections 153a-1, 153b-1 in the respective groove sections 153a-2, 153b-2.

The gear pump 160 has an external gear pump design, comprising a first gear 161 and a second gear 162. The first gear 161 comprises a hexagonal central hole 161a configured to receive the drive shaft 165 via the drive shaft opening 158 in use. The hexagonal central hole 161a is configured such that the drive shaft 165 engages with the hexagonal central hole 161a and rotates the first gear 161 on rotation of the drive shaft 165.

The second gear 162 comprises a circular central hole 162a. The first portion 151a of the body 151 comprises an axle 166. The axle 166 and the circular central hole 162a are configured such that the second gear 162 can be mounted to the axle 166 for free rotation thereon.

The drive shaft opening 158, axle 166, first gear 161 and second gear 162 are arranged such that when the first gear 161 is arranged to receive the drive shaft 165 provided at the drive shaft opening 158 and the second gear 162 is mounted to the axle 166, teeth of the first gear 161 mesh with teeth of the second gear 162. Rotation of the first gear 161 relative to the body 151 thereby rotates the second gear 162 relative to the body 151. The teeth of the gears 161, 162 move sealant through the cavity 156 as the gears 161, 162 rotate relative to the body 151, in use. The volume of sealant dispensed at the output port 154 is determined, at least in part, by the shape of the teeth of the gears 161, 162.

The cavity 156 is shaped such that the components of the gear pump 160 are tightly confined. That is, there is only a small separation between the gears 161, 162 and the surrounding cavity 156. In this way, the gears 161, 162 of the gear pump 160 are free to rotate, but flow of sealant around the gears 161, 162 is reduced or avoided. This reduction or avoidance of uncontrolled flow of sealant through the cavity 156 improves control of the volume of sealant dispensed by the gear pump module 150.

The gear 161 driven by the drive shaft comprises a groove 163a (not directly visible in FIG. 2) forming a perimeter around the hexagonal central hole 161a. A corresponding ridge 163b located on the first portion 151a of the body forms a perimeter around the drive shaft opening 158. The groove 163a on the gear 151 receives the ridge 163b around the drive shaft opening 158 to form a labyrinth seal, permitting rotation of the gear 161 as the ridge 163b tracks through the groove 163a while preventing or reducing leakage through the drive shaft opening. In other examples, the perimeters around the hexagonal central hole 161a and drive shaft opening 158 are alternatively or additionally configured to receive an o-ring between the gear 161 and the first portion 151a of the body, again to form a seal around the drive shaft opening 158 and prevent or reduce leakage.

The first portion 151a, the second portion 151b, the first gear 161, and the second gear 162 are each monolithic structures manufactured by additive manufacturing techniques. They are made of polylactide (PLA) plastic filament. In other examples, other suitable materials for additive manufacture may be used, such as Nylon PA12. The materials may be recyclable or biodegradable. In other examples, any of the first portion 151a, the second portion 151b, the first gear 161 and the second gear 162 may be injection molded.

The gear pump module 150, being manufacturable from low-cost materials, including recyclable or biodegradable materials, and being manufacturable by a low-cost method such as additive manufacture or injection molding, is therefore readily disposable. This can effectively remove or reduce the requirement to clean the gear pump module 150 in-between uses. This can limit operator exposure to harmful cleaning substances. In examples where the gear pump module 150 is manufactured from polyethylene, it may be possible to re-use the gear pump module 150 a number of times by allowing the sealant to cure within the gear pump module 150. The gear pump module 150 is subsequently split open into the two constituent portions 151a, 151b and the sealant straightforwardly removed without residue.

The components of the sealant application system gear pump module 150, such as the first portion 151a, the second portion 151b, the first gear 161, and the second gear 162, may be provided as a kit of components. Providing such a kit can increase the portability of the gear pump module 150, which can be assembled at the point of use. For example, where the components are injection molded, they may be provided within the frame of sprue and runners which result from their manufacture.

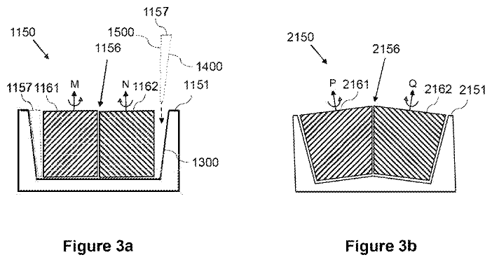

FIGS. 3a and 3b illustrate further examples of the gear pump module, in particular design variations on the body, cavity and gears. Features as described for the gear pump module 150 of FIG. 2 can be considered to be implicitly included in the gear pump modules of FIGS. 3a and 3b, unless specified otherwise.

FIG. 3a shows a cross-sectional view of a first body portion 1151 of a gear pump module 1150 comprising two gears 1161, 1162. The first gear 1161 rotates around a first axis of rotation, indicated by an arrow M, and the second gear 1162 rotates around a second axis of rotation, indicated by an arrow N, wherein the first axis of rotation M is parallel to the second axis of rotation N. The first body portion 1151 is produced by an injection molding technique, and so internal walls 1300 of the first body portion 1151 defining a first half of a cavity 1156 are sloped in order to produce a draft angle suitable for the injection molding technique (i.e., suitable for removal of the first body portion 1151 from a mold). Inserts 1157 comprise sloped walls 1400 which are complementary to the draft angle of the internal walls 1300 of the first portion 1151. That is, an insert 1157 can be positioned within the cavity 1156 such that the sloped walls 1400 of the insert 1157 are adjacent and parallel to the internal walls 1300 of the first body portion 1151. In such a position, the internal walls 1500 of the insert 1157 form new boundaries of the cavity 1156 which are parallel with each other. When the insert 1157 is positioned within the first body portion 1151 in this way, the internal walls 1500 of the cavity 1156, being parallel with each other, more tightly confine the gears 1161, 1162, improving the performance of the gear pump module 1150. In such an example, therefore, the first body portion 1151 and inserts 1157 may both be injection molded and hence comprise sloped walls, but the combination of the first body portion 1151 with the insert 1157 results in a cavity 1156 comprising parallel walls. In this example, two inserts 1157 are present but in other examples, a single insert may be provided to achieve the result described above, or more than two inserts may be provided.

FIG. 3b shows a cross-sectional view of a first body portion 2151 of a gear pump module 2150 comprising gears 2161, 2162. In this example, the gears 2161, 2162 of the gear pump module 2150 have respective tapered profiles. That is, the gears 2161, 2162 have a larger cross-sectional surface area at one axial end compared with the other axial end, such that the gears 2161, 2162 are conical frustums. Similarly to the example of FIG. 3a, the internal walls of the first body portion 2151 are sloped according to a draft angle such that the first body portion 2151 can be more easily manufactured through injection molding. The gears 2161, 2162 are tapered complementarily with the sloped internal walls of the first body portion 2151, such that the surface of the gears 2161, 2162, when mounted in the cavity 2156, are parallel to the sloped internal walls of the first body portion 2151. In order to permit rotation of the tapered gears 2161, 2162, the first gear 2161 rotates around a first axis of rotation, indicated by an arrow P, and the second gear 2162 rotates around a second axis of rotation, indicated by an arrow Q, wherein the first axis of rotation P is not parallel to the second axis of rotation Q. In this way, the first body portion 2151, first tapered gear 2161, and second tapered gear 2162 are suitably shaped for injection molding, as they each comprise a profile comprising a draft angle. While each profile comprises a draft angle, adjacent surfaces within the gear pump module 2150 are parallel such that the gear pump mechanism remains tightly confined within the cavity 2156. The gear pump mechanism can thereby accurately dispense sealant.

The above embodiments are to be understood as illustrative examples of the disclosure herein. Further embodiments of the disclosure herein are envisaged:

The stepper motor 168 can be considered a dosage control unit. In other examples, the dosage control unit may comprise additional or alternative components. For example, a computer processor running software which interfaces with the stepper motor may be provided. The computer processor and associated software are operable such that an operator of the gear pump module or sealant application system can select a dosage size, whereupon the computer processor uses a calibrated algorithm to determine the number of stepper motor rotations required to dispense the selected dosage size, where the algorithm is calibrated based upon, for example, the type of sealant being used, the pressure provided to the sealant, the nozzle structure, and the specific gear pump module being used. This dosage selection can occur during usage of the gear pump module or sealant application system by the operator, such that it is dynamically modifiable. The dosage size may correspond to a numerically defined dosage volume such as 10 cubic millimetres, for example, or a dosage mass, such as 1 gram, for example. The dosage size may alternatively relate to a specific component such as, for example, a Jurblami cap or a nut cap. In other examples, the dosage control unit may be achieved mechanically, without a processor, wherein the dosage control unit enables a predetermined discrete rotation of the gears of the gear pump, to thereby cause a predetermined, discrete dose of sealant to be dispensed.

The dosage control unit may comprise a trigger which interfaces with the dosage control unit and which, when pulled, causes the sealant application system or gear pump module to dispense a single dose of sealant. In examples, the trigger may be further switchable between a single-dose mode and a continuous flow mode, where sealant is dispensed as long as the trigger is pulled. In this way, the dosage control unit enables the gear pump module or sealant application system to be driven in any of a manually operated, semi-automated and fully automated manner. Control of the sealant dosage can reduce over-application of sealant, reducing unnecessary weight added to, for example, aircraft, and reducing resource waste.

In the above examples, the gear pump has an external gear pump design, or topology. In other examples, other designs of gear pump design may be used, such as an internal gear pump design, a rotary lobe pump, or a rotary vane pump, all of which terms would be understood by the skilled person.

In the above examples, the input and output ports comprise threaded fittings, but in other examples, other fittings may be used, such as a taper-lock fitting.

In the above examples, a labyrinth seal, which is capable of operating without leakage in the time scales over which the nozzle will be used, is provided. In other examples, other approaches can be used, additionally or alternatively to the labyrinth seal. For example, a rubber O-ring can further improve the seal between the first portion and the second portion. In other examples, ultrasonic or solvent welding can secure the first portion to the second portion and thereby improve the seal.

The drive shaft opening 158 may not be present at point of manufacture, but instead added later. For example, a knock-out portion may be provided at the location of the drive shaft opening, the knock-out portion being forcibly removable from the body to form the opening into the cavity. Such a knock-out portion may be a region of thinner material, or a portion bounded by a perimeter of thinner material, for example the material being scored or molded more thinly.

For example, the gear pump module body may be symmetrical such that it can be formed by a first portion and a second portion that are identical to each other. This can reduce the cost of manufacture by reducing the number of unique parts to be manufactured, reducing investment tooling costs. This can further improve the disposability of the gear pump module. In such examples both portions may comprise an axle, for example. The input ports and output ports may both be female threaded, or both be male threaded. Both portions may comprise a knock-out portion as discussed above, with only one knock-out portion needing to be removed to assemble the gear pump module.

It is to be understood that any feature described in relation to any one embodiment may be used alone, or in combination with other features described, and may also be used in combination with one or more features of any other of the embodiments, or any combination of any other embodiments. Furthermore, equivalents and modifications not described above may also be employed without departing from the scope of the disclosure herein, which is defined in the accompanying claims.

It is to be noted that the term “or” as used herein is to be interpreted to mean “and/or”, unless expressly stated otherwise.

It should be understood that modifications, substitutions and alternatives of the invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A sealant application system, comprising:
an interface structure comprising an interface for interfacing with a source of sealant;
a nozzle structure comprising a nozzle for dispensing sealant; and
a gear pump module comprising a gear pump, the gear pump module being detachably connectable to each of the interface structure and the nozzle structure such that sealant provided at the interface is pumpable by the gear pump from the interface to the nozzle.

2. The sealant application system of claim 1, wherein the gear pump module is configured to receive a drive shaft for driving the gear pump, and the sealant application system comprises the drive shaft.

3. The sealant application system of claim 1, wherein the sealant application system comprises a motor operable to drive the gear pump.

4. The sealant application system of claim 1, wherein the sealant application system comprises a source of sealant, the source of sealant interfaceable with the interface structure.

5. The sealant application system of claim 1, comprising a device operable to apply pressure to the source of sealant such that sealant is provided to the interface under pressure.

6. The sealant application system of claim 1, comprising a sealant dosage control unit configured to cause driving of the gear pump module such that the sealant application system dispenses a selectable dosage of sealant from the nozzle.

7. A sealant application system gear pump module for a sealant application system, the sealant application system gear pump module comprising:
a body defining:
an input port detachably connectable to an interface structure, the interface structure comprising an interface for interfacing with a source of sealant;
an output port detachably connectable to a nozzle structure, the nozzle structure comprising a nozzle for dispensing sealant; and
a cavity that fluidically connects the input port to the output port; and
a gear pump in the cavity and operable to pump sealant received at the input port to the output port.

8. The sealant application system gear pump module of claim 7, wherein the sealant applicator gear pump module comprises discrete first and second portions, the first portion and the second portion being attached to each other to form the body.

9. The sealant application system gear pump module of claim 8, wherein each of the first portion and the second portion is a monolithic structure.

10. The sealant application system gear pump module of claim 8, wherein the input port and the output port are formed by attachment of the first portion to the second portion.

11. The sealant application system gear pump module of claim 8, wherein the first portion and the second portion are configured such that the cavity is sealed at adjoining surfaces of the first and the second portions.

12. The sealant application system gear pump module of claim 11, wherein the first and second portions are configured to form a labyrinth seal at their adjoining surfaces.

13. The sealant application system gear pump module of claim 8, wherein at least one of the first portion and the second portion comprises a knock-out portion, the knock-out portion being forcibly removable from the at least one of the first portion and the second portion to produce an opening into the cavity configured to receive a drive shaft for powering the gear pump.

14. The sealant application system gear pump module of claim 8, wherein the first portion and the second portion are identical to each other.

15. The sealant application gear pump module of claim 7, wherein the body comprises an opening configured to receive a drive shaft for powering the gear pump.

16. The sealant application system gear pump module of claim 7, wherein the sealant applicator gear pump module comprises additively manufactured components.

17. The sealant application system of claim 1, wherein the gear pump comprises an external gear pump.

18. The sealant application system of claim 1, wherein a gear of the gear pump comprises a non-circular central hole such that the gear is configured to receive, and be driven by, a drive shaft.

19. The sealant application system gear pump module of claim 7, wherein the input port and the output port comprise male or female threaded fittings.

20. A kit of components that are operable to be assembled to form the sealant application system gear pump module of claim 8, the kit of components comprising:
the first portion and the second portion, which are attachable to each other to form the body; and
two or more parts that are operable to be assembled to form the gear pump.
